(19) United States
(12) Patent Application Publication
(10) Pub. No.: US 2005/0210996 A1
(43) Pub. Date: Sep. 29, 2005

(54) Flow channel structure and method

(76) Inventors: John G. Quinn, Dallas, TX (US); Richard A. Carr, Rowlett, TX (US)

Correspondence Address: TEXAS INSTRUMENTS INCORPORATED, P O BOX 655474, M/S 3999, DALLAS, TX, 75265, US

(21) Appl. No.: 10/799,283

(22) Filed: Mar. 12, 2004

(51) Int. Cl. G01N 1/10

(52) U.S. Cl. 73/861

(57) ABSTRACT

A microfluidic analysis system with a flow channel block, possessing at least one recessed channel, clamped to a sensor surface, such as a surface plasmon resonance (SPR) sensor. Flatness and hardness lead to a liquid leak-proof seal. Surface tension forces prevent liquid from leaking between the flow cell block and sensor surfaces. The fluid channels formed are reversible upon removal of the clamping pressure.

### BACKGROUND OF THE INVENTION

The present invention relates to analytical chemical measurements, and more particularly to microfluidic devices and methods of manufacture and use.

Analytical instruments such as biosensors are well established as a means of recording the progress of biomolecular interactions in real time. Biosensors are analytical instruments that employ a variety of transduction technologies in order to detect interactions between biomolecules. Such instrumentation requires microfluidic channels in order to deliver samples to a sensing region. Pumps and valves are prefered to provide a means of moving sample through the channels in a controlled reproducible manner. There are several transducers capable of recording the progress of biomolecular interactions, for example a quartz crystal microbalance. Binding of molecules to the surface of a quartz crystal changes the fundamental resonance frequency which allows quantitation of the binding event. Other technologies include light scattering, reflectometric interference spectroscopy, ellipsometry, fluorescence spectroscopy, calorimetry, and evanescent field based optical detection. A particularly effective evanescent field based technology, known as surface plasmon resonance (SPR), exploits the behavior of light upon reflection from a gold-coated optical substrate.

SPR is an optical technique that enables real-time monitoring of changes in the refractive index of a thin film close to the sensing surface. The evanescent field created at the surface decays exponentially from the surface and falls to one third of its maximum intensity at approximately 300 nm from the surface. Hence the SPR technique is sensitive to surface refractive index changes and is almost completely insensitive to refractive index variations greater than 300 nm from the surface. An integrally-formed miniature SPR transducer has previously been described in U.S. Pat. No. 5,912,456. In this device a photodiode array (PDA) simply records the intensity of the reflected light, from an light emitting diode (LED) over a range of angles. Refractive index changes within the penetration depth of the evanescent field give rise to corresponding changes in the position of the SPR reflectance minimum. This change in resonance angle is followed by tracking the change in the pixel position of the reflectance minimum. A minimum tracking algorithm is employed to continuously monitor the position of this minimum as it traverses the photodiode array and the pixel position is then related to a refractive index value. The current configuration of this device possesses three SPR active sensing regions per sensor enabling multichannel operation with real-time reference subtraction. Alternative configurations can allow as many as 100 SPR sensing regions.

Temperature control is important as changes in temperature give rise to a drifting baseline. A change of 1 degree C. will cause a baseline shift of 1×10⁻⁴ refractive index unit (RIU). This must be controlled in order to make accurate measurements. A small amount of heat is generated by the LED and PDA and is conducted away from the SPR surface using a heat sink and suitable interface materials. In this way it is possible to attain very low baseline drift, for example, less than 0.30×10⁻⁶ RIU/min.

The delivery of samples to the SPR active sensing regions is made possible by creating flow channels that cover the active sensing regions. Each flow channel possesses an inlet and outlet to allow for the flow of buffer, or samples, over the SPR active sensing regions. The gold surface is derivatized to possess a polymeric coating that enables biomolecules to be permanently immobilized. The immobilized biomolecules usually possesses binding specificity for another biomolecule contained in the sample. The strength of this binding is given by the affinity constant which is simply the ratio of the binding rate divided by the rate of dissociation. It is possible to measure these constants because an SPR-based biosensor records the progress of binding and dissociation events in real time.

The scaling down of biochemical analysis instruments has important advantages. For example, U.S. Pat. No. 5,376,252 discloses planar microfluidic structures useful for capillary electrophoresis. The channels of these microfluidic structures may have diameters in the range of 50-250 μm and may be manufactured by molding trenches into the surface of a first thermoplastic base and then clamping a second base to the first base which thereby covers the trenches to form channels.

Similarly, U.S. Pat. No. 6,375,871 discloses a method of manufacturing microfluidic devices by attaching two layers with a molded channel pattern in one layer, the attachment is by double-sided adhesive tape. The two layers may be pattern-molded polymethylmethacrylate (PM MA) and polyimide.

The integrally-formed miniature SPR transducer as described in U.S. Pat. No. 5,912,456 is a disposable element. Such a sensor requires a flow channel block that forms a reversible leak tight seal with the sensor's SPR active sensing regions. Permanent attachment of a flow channel to the SPR active sensing region is possible but this is difficult to achieve without damaging the surface chemistry attached to the active sensing region. Damage can occur due to chemical and/or mechanical damage during the flow channel attachment process. In addition, making reliable, and reversible, fluid connections with the flow channel inputs is difficult. Any change in dead volume changes the arrival time of sample at the flow channels. Such delays decrease the reproducibility of binding responses from one SPR channel to the next and also make reference subtraction more difficult.

There are many factors that have a large influence on the performance of the biosensor and the quality of the analytical data recorded. Of particular importance is the flow channel's physical properties. The dimensions of the flow channels and the material composition of the flow channel block have a large influence on data quality. In addition to flow channels, it is possible to integrate valves into the same flow channel block in order to enable complex fluid processing to be accomplished without the need for additional free standing valve assemblies.

For example, U.S. Pat. No. 5,376,252 and U.S. Pat. No. 5,313,264 describe flow channels and integrated valves on a single multilayer card that is fabricated by molding techniques using liquid precursors of elastomers and hard plastic laminates. Molded silicone rubber forms the flow channels that interface with the SPR sensing surface and another silicone rubber layer provides a flexible diaphragm layer for the construction of pneumatically actuated pinch valves. This integrated microfluidic cartridge is prone to clogging and needs to be replaced regularly.

Silicone rubber seals readily against surfaces due to its ability to deform to meet the contour of the opposing material giving a conformal seal. In addition, silicone rubber is chemically inert and biocompatible. Very little pressure is required to form a seal using flow channels formed in silicone rubber but the elasticity of silicone rubber also makes it difficult to hold tight tolerances on the flow channel dimensions. Any change in the pressure applied to secure the flow channel, or liquid pressure within the flow channel, will tend to change the flow channel dimensions, especially the channel height. Holding these dimensions is critical in ensuring high analytical reproducibility. For example, it is usual to use the data from a reference channel to correct data from a working channel in order to subtract baseline drift and non-specific binding. This reference subtraction method will not be effective if the flow channel dimensions for each channel are significantly different (i.e., greater than 5% variation).

Therefore, systems employing flow channels made of silicone elastomer require careful design to ensure that these pressures are constant. These design constraints add expense and/or technical difficulty to operating such SPR instruments. Silicone rubbers also leach residues (e.g., residual curing agents or precursors) that contaminate the SPR active sensing region. In addition, they are slightly porous and may significantly absorb solution and biomolecules.

The geometry of the flow channel must be maintained in order to ensure reproducible analytical performance. Indeed, the SPR signal is averaged over the SPR active area, and the transport of the biomolecule of interest (analyte) contained in the sample to the SPR active surface results from convective and diffusion forces. These phenomena are described by the mass transfer coefficient (kₘ) and are related to the flow channel dimensions and operational flow rate according to the following expression.

$${k}_{m} = C \sqrt[3]{\frac{{D}^{2} F}{{h}^{2} {bl}^{2}}} \qquad ( 1 )$$

where D=Diffusion coefficient of the analyte (m²/s)
h, b, l=Height, width, and length of flow channel (m)
F=Bulk flow rate (μl/min)
C=Constant

Stringent biomolecular interaction applications require that a stable analyte concentration gradient exists and this requires laminar flow conditions. Flow channels with heights that exceed 0.5 mm (500 μm) are often characterized by non-laminar flow conditions. Turbulent flow conditions must be avoided if analytical reproducibility is required. It is obvious from equation (1) that mass transport rates are greatly influenced by the size of the flow channel (particularly the flow channel height) and this has a large effect on the magnitude of binding signals that may be detected. Thus every effort should be made to ensure that the flow channel dimensions are fixed. In addition, miniaturization of the flow channel dimensions will ensure that mass transport rates are high. If mass transport rates are low, as is the case with large flow channels, then the majority of the biomolecular interaction data will represent mass transport rates and not the kinetic constants for the interaction. This is particularly true when the binding rate of the analyte to the immobilized biomolecule (i.e., ligand) is high.

There is a practical limit to the miniaturization of the flow channel dimensions and this is dictated by considerations of contact area, backpressure, and fluid dynamics, as follows.

Flow channel contact area:

The smaller the flow channel area in contact with the sensing surface the greater the binding response observed. If the flow channel area in contact with the surface increases 2-fold, then the ligand binding response will decrease by 50%. This is intuitive as the same number of bound molecules are averaged out over a greater area. The SPR signal records the averaged mass increase per unit area.

Backpressure:

The theoretical flow resistance in a rectangular channel, with a high aspect ratio (i.e., the width is far greater than the height), can be estimated from the Poiseuille slot flow equation where,

$$R = \frac{12 μ L}{{wh}^{3}} \qquad ( 2 )$$

where μ=Solution viscosity
L=Length of channel (i.e., flow channel)
w=Width of channel
h=Height of channel

The backpressure will scale inversely according to the cubic power of the channel height. This shows that decreasing the flow channel height by 2-fold will give an 8-fold increase in resistance to flow. If the resistance is high, then the flow channel seal must be leak proof above that pressure. Therefore, flow channel heights below 15 μm are not practical for low pressure systems. In addition, flow channels below this height are easily blocked by particulates that are often present in unfiltered samples and buffers. In addition, the internal diameter of tubing used to deliver sample to each flow channel should be greater than 50 μm in order to avoid excess backpressure. In addition excess backpressure causes delays in reaching a steady-state flow. Such delays have significant effects on the performance of the biosensor system. In particular, the time required for a full exchange of running buffer with sample within each SPR flow channel will be delayed. If a bulk refractive index variation exists between the running buffer and sample, then the response due to this bulk index response is difficult to resolve from the actual binding signal, without using a reference channel, unless the exchange time can be reduced (i.e., to less than 10 seconds).

Fluidic dynamics and gradients:

Laminar flow through a small channel is described by a parabolic flow profile where the velocity of the liquid at the walls is zero and the velocity is maximal towards the center of the channel. These velocity gradients cause uneven distribution of analyte binding at the surface. In particular it is important that the SPR active surface is not positioned near the wall of the flow channel where the velocity, and hence analyte binding, is very low. The SPR active areas of the integrally-formed miniature SPR transducer of U.S. Pat. No. 5,912,456 are approximately 50 μm wide and 4 mm long, and, hence, the flow channel dimensions need to exceed these (i.e., 300 μm wide and 5 mm long). Turbulent flow will exist at the inlet and outlet causing unpredictable analyte binding. Therefore, the SPR active region should be centered along the middle of the flow channel, thereby seperating the active sensing regions from the walls, and the inlet/outlet holes.

Known microfluidic systems have problems including a lack of reversible flow channel seals with inelastic materials.

### SUMMARY OF THE INVENTION

The present invention provides microfluidic sensor systems having a hard, smooth flow channel block clamped directly to a sensor surface, such as a surface plasmon resonance (SPR) sensor. Preferred embodiments include methods of manufacture of preferred embodiment flow channel blocks.

This has advantages including: a flow channel block which does not deform or leach contaminating residues when assembled, thereby maintaining a clean and reproducible biomoleculer interaction environment. A reproducible seal defining a fixed flow channel volume is attained by simply pressing the hard flow channel block against a smooth, planar substrate such as an SPR sensor.

### BRIEF DESCRIPTION OF THE DRAWINGS

FIG. 1 illustrates a preferred embodiment microfluidic sensor system.

FIGS. 2a-2c illustrate preferred embodiment flow channel blocks.

FIG. 3 is a flow diagram for a preferred embodiment method of manufacture.

### DESCRIPTION OF THE PREFERRED EMBODIMENTS

1. Overview

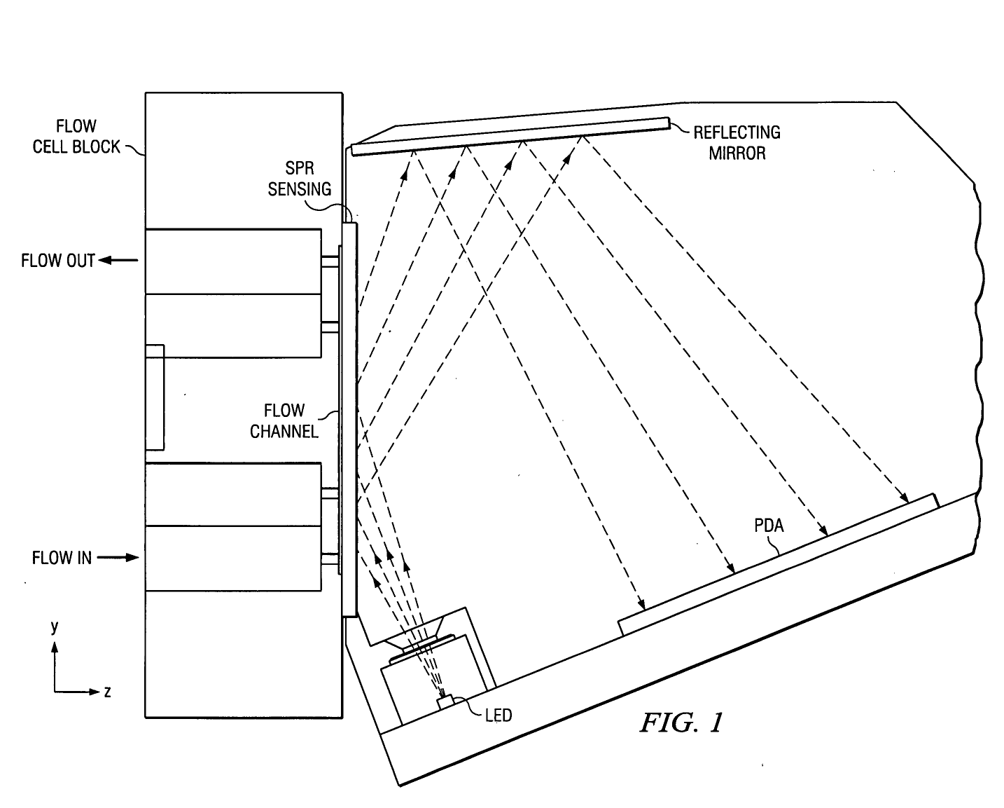

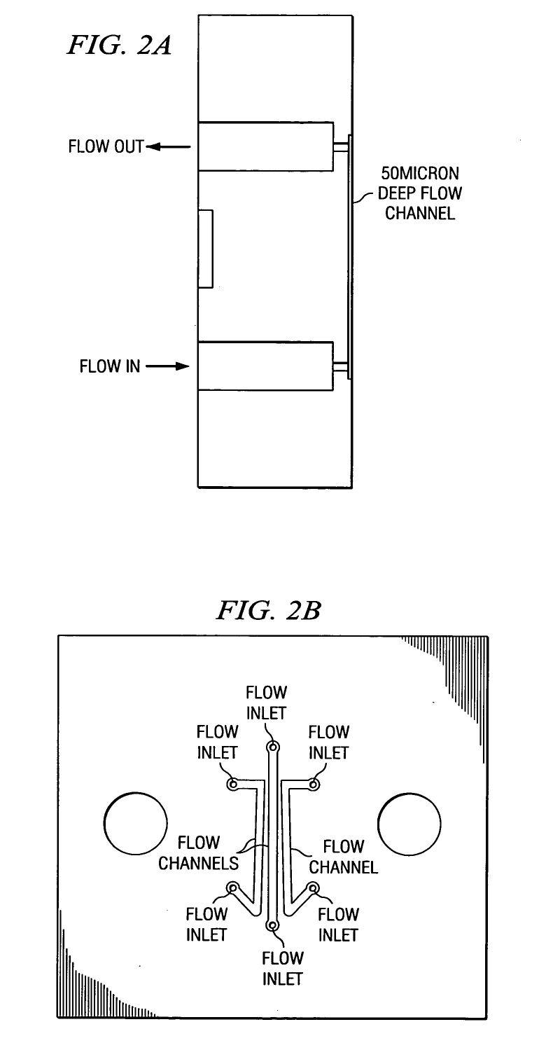

Preferred embodiment microfluidic devices have a flow channel block with a hard, smooth surface including recesses that define microfluidic flow channels. The recessed block surface is clamped to the sensor surface of a surface plasmon resonance (SPR) device to form a microfluidic channeled sensor system. The SPR sensing surface would typically be glass with a deposited thin (e.g., 50 nm thick) gold coating and an analyte-binding layer (e.g., 100-500 nm thick) bonded to the gold. FIG. 1 illustrates in cross sectional elevation view a preferred embodiment sensor system with the flow channel block in the left-hand portion of the Figure and the SPR sensor in the center and right-hand portion; FIGS. 2a-2b are side elevation and plan views of a preferred embodiment flow channel block which has three parallel flow channels. FIG. 2c is an engineering drawing showing a perspective view of this flow channel block.

Since there is no adhesive with the clamped preferred embodiment systems, the flow channel block can be quickly replaced. The flow channel block surface roughness is less than 0.1 μm rms (root mean square) with a flatness (deviation of mean surface level) of the same order for the contact area; this allows a clamped connection to maintain a liquid seal at the operational fluid pressures within the fluidic system. The liquid seal primarily results from surface tension forces that prevent liquid from passing freely through the sub-micrometer-sized gaps that remain when the flow channel is clamped in position. Note that typically the SPR sensor surface has a hydrogel bonded to a SAM on a gold film, and this make the contact with the flow channel block surface. Also, for lower pressures preferred embodiments may have surface roughness of up to 0.5 μm rms and with a comparable flatness.

A preferred embodiment method of manufacture employs direct machining of the recessed channels into a flow channel block machined from carbon-filled poly-etheretherketone (PEEK). The surface of the flow channel block is then polished to give the required flow channel height, roughness and flatness. A glass plate is used as the final polishing surface. The surface roughness of the polished flow channel block is similar to that of the glass plate used for polishing and is less than 0.1 μm (root mean square).

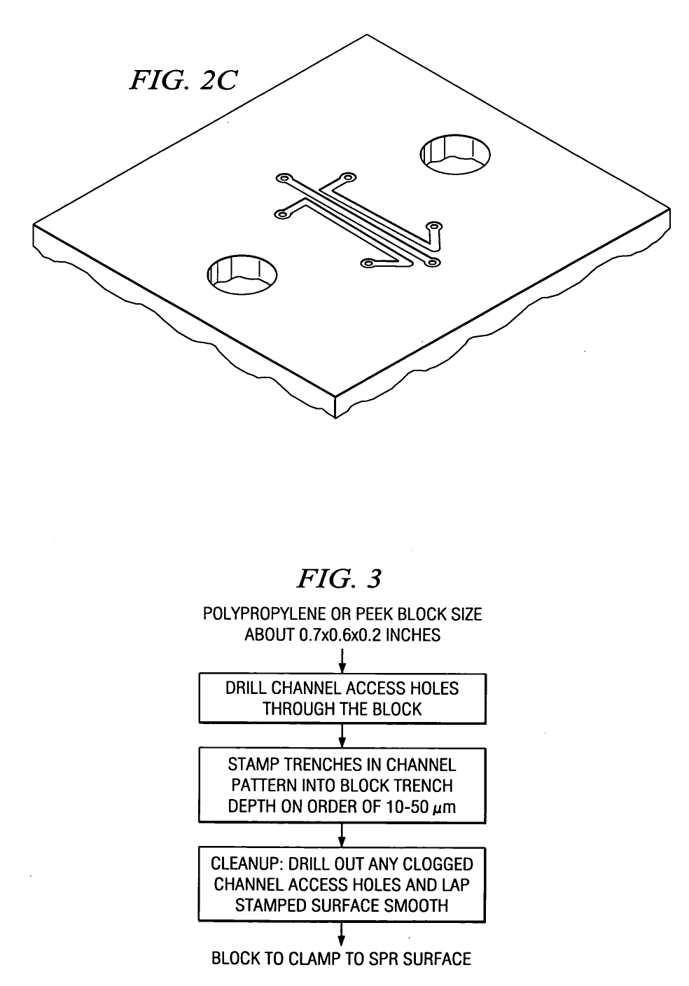

In a second preferred embodiment manufacturing method the flow channel block surface is stamped with a heated copper die to form the channel (recess) pattern. The surface is polished to give the required flow cell channel height, roughness and flatness. FIG. 3 is a manufacturing method flow diagram.

2. Surface Plasmon Resonance (SPR) System

FIGS. 1 is a side elevation view of a first preferred embodiment microfluidic surface plasmon resonance (SPR) sensor system which includes a preferred embodiment flow channel block clamped to an SPR device with a clamping pressure in the range of 100-2000 psi; the SPR device includes a glass substrate with a detection surface layer together with a radiation source and an array detector. FIGS. 2a-2c are engineering drawings of the flow channel block alone. A microfluidic flow channel is formed by a recess in the flow channel block face abutting the coated glass substrate sensor surface layer, and access holes in the flow channel block allow input to and output from the flow channel. Tubing for a carrier liquid phase and injected samples would be attached to the input and output access holes during operation. A multiport valve is used to control the deliver of running buffer and samples to the flow channels.

The SPR active sensing surface exposed in the center of the flow channel is functionalized with a polymeric coating that provides binding sites for analyte in liquid samples passing through the flow channel. Flow channel block properties are discussed in following paragraphs (a)-(g) within the context of fabricating the flow channel block from carbon-filled PEEK and may change to include other materials.

(a) The surface of the flow channel block with recessed channels must possess a surface roughness of less than 0.5 μm (or, preferably less than 0.1 μm) where roughness is measured as the root-mean-square of the block surface for the area to contact the sensor surface. The flatness must also be in the sub-micrometer range. Unlike flow channels molded from elastomers, the preferred embodiment flow channel block cannot conform to any imperfections at the interface formed when the flow channel block is pressed against the sensing surface. The surfaces of the flow channel block and the sensor are both smooth and flat leaving spaces in the sub-micrometer range when pressed together. Surface tension forces impose a high resistance to flow at the sub-micrometer scale thus preventing leaks from the flow channel. Leaks do not occur unless the fluid pressure is increased well beyond the operational pressure (e.g., 20 psi). In contrast to flow channels molded from elastomers, where a seal can be made despite significant roughness or geometry, it is the resistance of fluid to flow between very small spaces due to surface tension effects. This seal cannot tolerate micrometer-sized variations in flatness or roughness.

The flow channel block surface possessing the recessed channels is polished to give a consistent and reproducible flow channel height. The final surface roughness and flatness are obtained by polishing over a smooth glass plate. The interaction of the contacting surfaces under an applied load in relative motion removes asperities from the flow channel block surface. In particular, any carbon fibers protruding from the face will also be polished by the hard glass surface to yield a flow channel block surface with a surface roughness less than 0.1 μm. Note that 30% carbon-fiber-filled PEEK possesses exceptional resistance to wear; this may be inferred from its mechanical properties listed in Table 1. The equivalent values for hard silicone rubber (i.e., the hardest silicone rubber that can be made) are given for comparison. The hardness measurements are with the Shore Durometer with type D indentor.

TABLE 1

| | 30% Carbon | |
|---|---|---|
| | fiber filled Ketron | Hard Silicone |
| | PEEK | Rubber |
| Compressive Strength (psi) | 25,000 | up to 1600 |
| Hardness (Shore D) | D86 | D30 |
| Thermal Conductivity | 6.37 | <6.0 |
| (BTU. in/hr. ft². ° F.) | | |
| Water Absorption (7 days) | 0.5% | 1.0% |
| Elongation (%) | <200 | 500 |

(b) The flow channel block material must be hard to prevent distortion of the flow channel dimensions as the flow channel sustains a load pressure against the sensor face. Also hardness will enhance durability by resisting the formation of indentations when the flow channel block is repeatedly pressed against the sensing device. This ensures that a reproducible, reversible seal is formed each time a sensor is installed. Damage to the flow channel block surface would cause leaks in non-elastic flow channel materials. Hardness will also prevent damage from any accidental contact during sensor installation. Table 1 shows that carbon-fiber-filled PEEK is a very hard material with a Shore D hardness of D86. It also resists compression up to a load of 25,000 psi while the hardest silicone rubber is 16-fold more compressive. Indeed, the hardness of preferred embodiment flow channel blocks maintain a dimensional tolerance of ±1 μm after repeated sealings and unsealings with applied sealing pressures in the range of 200 to 5000 psi.

(c) The flow channel block material should be non-porous to prevent the adsorption of liquids and biomolecules. Carbon-filled PEEK is extremely non-porous and resists the adsorption of liquids and small biomolecules. Indeed, the preferred embodiments absorbs less than 0.1% water when immersed for 24 hours at 25 degrees Celsius.

(d) Ideally, the flow channel block material should conduct heat to promote rapid temperature equilibration at the sensing surface. Carbon-filled PEEK has good thermal conductivity (i.e., 6.37 BTU-in/hr-ft²-°F).

(e) The flow channe block material should be blackened to adsorb stray light that penetrates the SPR surface of the sensor. The integrally-formed miniature SPR transducer of U.S. Pat. No. 5,912,456, does not employ lenses to focus light from the LED onto the active sensing surface. The sensor is designed to absorb any stray light thus preventing the light from interfering with the SPR reflectance signal. A fraction of the LED light refracts across the SPR active surface and will be absorbed by the blackened flow channel block. The carbon-filled PEEK flow channel block absorbs light effectively owing to the black carbon-fibers embedded in the material. Indeed, the preferred embodiments absorb more than 80% of impinging light (400 nm to 1100 nm wavelengths) at incident anles from 50 to 80 degrees.

(f) The flow channel block material should be chemically resistant to common solvents and weak acids and bases. These solutions, or aqueous mixtures of them, are often required for general operation of a biosensing system. In addition, various solvents are occasionally employed. PEEK is one of the most chemically inert polymers known and resists all chemicals that would be required for routine operation of a biosensor. Indeed, preferred embodiment material in contact with the liquid phase leaches residues or particulates to a concentration less than 2 pg/mm²/min.

(g) The flow channel block may be fabricated by embossing techniques as described later or machined. The number of channels and the dimensions of the channels may change with new generations of the SPR transducer. However, in a preferred embodiment the flow channel block possesses three recessed channels on the front face. These channels are on the order of 50 μm to 500 μm wide, 1 mm to 10 mm long, and 20 μm to 100 μm high. FIG. 2b shows in plan view the pattern of recessed channels in the preferred embodiment block face. Each channel possesses inlet and outlet access holes allowing fluid communication with tubing, pumps, and valves. The FIGS. 2b-2c channels are approximately 5 mm long, 300 μm wide and 30 μm deep.

3. Manufacturing Methods

As mentioned previously, first preferred embodiment flow channel blocks are fabricated from PEEK and PEEK composite materials. However, the flow channel block may be fabricated from any material of low elasticity such as certain polymers, ceramics, metals or composites thereof. For example, the flow channel material may be a hard chemically-resistant polymer such as polypropylene or Delrin (polyformaldehyde). The preferred embodiments use materials with hardness (Shore D) of at least D50.

As illustrated in FIG. 3, the steps in a preferred embodiment method of making a flow channel block of the type shown in FIGS. 2a-2c include the following.
(1) Cut material into a rectangular block of desired dimensions; FIG. 2b shows a block of thickness 0.190 inch, width 0.676 inch, and length 0.625 inch.
(2) Lap the block surfaces to remove tooling marks.
(3) Drill alignment and access holes in the block; FIGS. 2b-2c show three pairs of access holes for three parallel flow channels plus two alignment holes and an alignment recess. Drill the alignment holes first, and use these alignment holes to align the block for drilling the access holes. (The same alignment holes will be used to align the die for stamping the flow channels.) Note that the access holes have a taper at the block face opposite the flow channels and step down from a diameter of 0.061 inch to a diameter of 0.006 inch (150 μm) for the last 0.020 inch at the block flow channel face. That is, the access hole diameter is about 50% bigger than the flow channel width (300 μm) where they will merge, so alignment of the stamping in following step (4) has some error tolerance.
(4) Stamp the three parallel flow channel trenches into the block flow channel face with a die; FIG. 2b shows the recessed pattern with the access holes indicated by broken-line circles. The die is a copper pattern of the trenches with a thickness of 50 μm to 100 μm on a polyamide substrate (such as a printed circuit board) which has two holes for alignment with the two alignment holes in the block drilled in step (3). The die is heated to 200 degrees C., and a pressure of roughly 1-2 MPa applied for roughly 2-3 seconds. Polypropylene has a melting temperature of 171-174° C. and a softening temperature range of roughly 138-155° C.
(5) Drill out the access holes (150 μm=0.006 inch diameter at the flow channel face) to remove any plastic which may have melted into the holes during the stamping.

(6) Lap the stamped surface smooth. This final lamping step requires very fine polishing paper. In a preferred embodiment method a smooth glass plate is used to confer a very low roughness to the recessed channel surface.

(7) Repeat steps (4)-(6), this ensures that the channels are 30 μm deep. The stamped block can then be clamped to a detection surface of the SPR sensor as illustrated in the cross-sectional elevation view of FIGS. 1.

In a second preferred embodiment the entire flow channel block, including its recessed channels are directly machined using a programmable CNC machine. The surface is then polished to yield the required channel height, smoothness and flatness. In a preferred embodiment the flow channel block surface with recessed channels is given a final polish over a glass plate in order to obtain a surface roughness of less than 0.1 μm and a flatness, over the sensor contact area, of less than 1 μm. Alternatively, laser ablation may be employed to introduce the recessed channels in the surface of the flow channel block.

4. Modifications

The preferred embodiments can be varied while maintaining the feature of a hard (Shore D at least D50), smooth (less than 0.1 μm rms roughness), and flat (less than 0.1 um rms mean level variation) surface for the flow channel block.

For example, the flow channel block surface smoothness may be relaxed to 0.5 μm rms roughness and the flatness to 1.0 μm rms and still maintain sufficient sealing at low pressures.

Further, the (carbon-filled) PEEK could be any of the closely related polymers (glass-filled or carbon-filled) PEAK (polyaryletherketone), PEK (polyetherketone), PEEK, or PEKK (polyetherketoneketone). Alternative polymers with sufficient hardness (Shore D50) and other properties include (reinforced) polyproplylene and Delrin (polyformaldehyde).

1. A microfluidic structure, comprising:
(a) a first body which has a first planar surface that contains at least one recessed area to define at least one microfluidic channel, wherein the first planar surface has a surface roughness of less than 0.5 μm; and
(b) a second body which has a second planar surface which is a sensing surface, wherein said first surface and said second surface are in contact;
(c) whereby at least one microfluidic sensor channel is formed.

2. The structure of claim 1, wherein either the first body or the second body contains at least one pair of inlet/outlet holes to allow for a sample to enter and exit said at least one microfluidic channel and contact said sensing surface.

3. The structure of claim 1, wherein the contact of said first surface and said second surface of (c) of claim 1 is reversible.

4. The structure of claim 3, wherein the first body dimensions hold to a tolerance of ±1 μm for repeated sealing where the applied load is 200 to 5000 psi.

5. The structure of claim 1, wherein the material of the first body at the first surface has a hardness of at least D50 as measured by the Shore D method.

6. The structure of claim 1, wherein the first body is made of carbon-filled PEEK at the first surface.

7. The structure of claim 1, wherein the first body material adsorbs less than 0.1% water when immersed for 24 hours at 25 degrees Celsius.

8. The structure of claim 1, wherein the first body material adsorbs at least 80% of light at incident angles from 50° to 80° when the light has a wavelength from 400 nm to 1100 nm.

9. The structure of claim 1, wherein the first body material in contact with a liquid phase leaches residues or particulates to a concentration less than 2 pg/mm²/min.

10. The structure of claim 1, wherein there are three microfluidic channels with each channel roughly 300 μm wide, 5 mm long, and 30 μm high.

11. The structure of claim 1, wherein there are a plurality of microfluidic channels.

12. A process for fabrication of a flow channel block, comprising:
(a) machining or stamping (using a die) at least one recess for a microfluidic flow channel into the surface of a body with hardness (Shore Durometer type D) of at least D50;
(b) polishing the recessed surface from step (a) to a surface roughness of less than 0.5 μm root mean square and a flatness of less than 1 μm root mean square.

13. A microfluidic sensor component, comprising:
(a) a body with a first planar surface that contains at least one recessed area to define at least one microfluidic channel, wherein the body at said first planar surface has a hardness of at least D50 as measured by Shore Durometer type D;
(b) whereby said first surface in contact with a second planar surface which is a sensing surface forms at least one microfluidic sensor channel.

14. The component of claim 13, wherein said first planar surface has a surface roughness of less than 0.5 μm rms.

15. The component of claim 13, wherein the body contains at least one pair of inlet/outlet holes to said at least one recessed area whereby a sample may enter and exit said at least one microfluidic channel and contact said sensing surface.
